(19) United States
(12) Patent Application Publication
(10) Pub. No.: US 2006/0123135 A1
(43) Pub. Date: Jun. 8, 2006

(54) Method and system for uniform message interchange

(76) Inventor: Leon Lu, Hsin-Ten City (TW)

Correspondence Address: J C PATENTS, INC., 4 VENTURE, SUITE 250, IRVINE, CA, 92618, US

(21) Appl. No.: 11/155,734

(22) Filed: Jun. 16, 2005

(30) Foreign Application Priority Data
Dec. 8, 2004 (TW) 93137922

(51) Int. Cl. G06F 15/16

(52) U.S. Cl. 709/246

(57) ABSTRACT

A method and a system for uniform message interchange are provided, which are used for message interchange across heterogeneous communication platforms. The method includes the following steps of processing a native message received from a sender platform, dividing the native message into a message interface part related to the communication protocol used by the sender platform and a message content part unrelated to the communication protocol, packaging the message interface part into a uniform message with the uniform message interchange protocol and adding the message content part into the uniform message, and transmitting the uniform message to a receiver platform with the uniform message interchange protocol such that the receiver platform converts the uniform message into the format used by the receiver platform.

### CROSS-REFERENCE TO RELATED APPLICATION

This application claims the priority benefit of Taiwan application serial no. 93137922, filed on Dec. 8, 2004. All disclosure of the Taiwan application is incorporated herein by reference.

### BACKGROUND OF THE INVENTION

1. Field of the Invention

The present invention relates to a method and a system for message interchange, and more particularly, to a method and a system for uniform message interchange across heterogeneous communication platforms.

2. Description of the Related Art

As communication system improves over the years, the communication platforms and message types that people use to communicate with each other, such as facsimile (fax), e-mails, the instant message, and the mobile phone short message, have gradually increased. The communication protocols used in these platforms are not the same and their message formats are different. Also, the original design only allows for communication between multiple points with same communication protocols, but not interchange between multiple points with different communication protocols. Therefore, in order to exchange data in the system, it is required that both sides, which use different communication protocols to communicate with each other, negotiate and define a common interchange protocol and format, and configure the corresponding interchange system. If the common interchange format for different communication protocols is not defined, mutual communication cannot be achieved.

FIG. 1 schematically shows a more complicated case. It is assumed that the facsimile company 101, the e-mail company 102, the telecommunication company 103, and the instant message company 104 use different communication platforms. It is also assumed that the facsimile company 101 has business relationship with the telecommunication company 103 and intends to interchange message with each other. In addition, the e-mail company 102, the telecommunication company 103, and the instant message company 104, all need to interchange message with each other. Therefore, four sets of interchange system are required to fulfill these requirements as shown in FIG. 1. Further, two sets of interchange system are required if the facsimile company 101 intends to interchange messages with the e-mail company 102 and the instant message company 104 in the future.

The drawback of such method is that there is no uniform interchange specification, thus it is required to redesign the communication method for interchanging the message format between the new added platform and other platforms when there is a new platform or new message format to be added. The maintenance and upgrade are relatively complicated with the increase of the platform types, thus it is not only time-wasting and cost-adding, but also lacks efficiency.

Therefore, a better solution for the above problem is required, such that the cost of message interchange across platforms can be reduced and efficiency of developing the system can be improved.

### SUMMARY OF THE INVENTION

Therefore, a method and a system for uniform message interchange are provided in the present invention. With such method and system, the delivery of the messages across platforms is simplified and only related to the sender information, receiver information, and the contents to be delivered, but is unrelated to the details of the various communication protocols, such that the cost of message interchange across platforms is reduced and efficiency of developing the system is improved.

The present invention further provides a method for uniform message interchange. The method includes the following steps of providing a native message by a sender platform, dividing the native message into a message interface part related to the communication protocol used by the sender platform and a message content part remaining after removing the message interface part, packaging the message interface part into a uniform message using the uniform message interchange protocol and adding the message content part into the uniform message, and transmitting the uniform message to a receiver platform using the uniform message interchange protocol such that the receiver platform converts the uniform message into the format used by the receiver platform.

The present invention further provides a system for uniform message interchange. The system includes a sending device for dividing the native message into a message interface part related to the communication protocol used by a platform of the sending device and a message content part remaining after removing the message interface part, and packaging the message interface part into a uniform message with the uniform message interchange protocol and adding the message content part into the uniform message, and a receiving device for receiving the uniform message from the sending device and transmitting the uniform message into the format used by the platform of the receiving device.

The present invention further provides a system for uniform message interchange. The system includes a sending device for providing and sending a native message, a processing center for receiving the native message from the sending device and dividing the native message into a message interface part related to the communication protocol used by the platform of the sending device and a message content part unrelated to the communication protocol, and using the uniform message interchange protocol to integrate the message interface part and the message content part into a uniform message and to send the uniform message using a uniform message interchange protocol, and a receiving device for receiving the uniform message from the processing center and transmitting the uniform message into the format used by the platform of the receiving device.

The present invention mentioned above is mainly characterized in that the uniform message and the uniform message interchange protocol both unrelated to the various communication platforms are used as a communication medium herein. First, all of the native messages from various communication platforms are converted to the uniform message that uses the uniform message interchange protocol. Then, the uniform message interchange protocol is used to transfer the uniform message among platforms with different communication protocol. Finally, the receiver platform converts the received uniform message into the format that the platform uses. Therefore, it is only required to develop an interchange system among various communication platforms and the uniform message interchange protocols, but not to develop an interchange system for each combination of the various communication platforms. Accordingly, the delivery of messages across platforms is simplified and is unrelated to the details of the various communication protocols, such that the cost of message interchange across platforms is reduced and the efficiency of developing the system is improved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a method of interchanging messages across various communication platforms in the prior art.

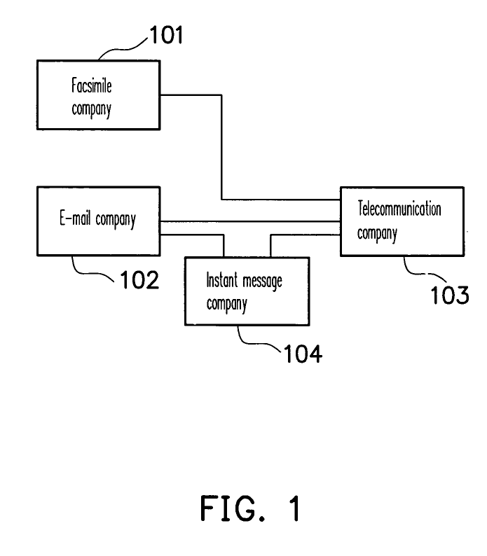

FIG. 2 schematically shows a flow chart illustrating a method for uniform message interchange according to the present invention.

FIG. 3 schematically shows a diagram of a system for uniform message interchange according to the present invention.

FIG. 4 schematically shows a diagram of another system for uniform message interchange according to the present invention.

FIG. 5 schematically shows a detailed diagram of a uniform message used in the method and system according to the present invention.

### DESCRIPTION OF THE EMBODIMENTS

The uniform message interchange protocol (UMIP) unrelated to the communication protocol of various communication platforms is used in the present invention to transfer data with the uniform message format among various communication platforms, such that the message is interchanged across platforms. Basically, the UMIP contains a message content which is sent to the receiver by the sender, a sender identification information, a receiver identification information, a type of the sender platform, and a type of the receiver platform. Normally, the details of the communication protocol used by any communication platform are not included in the UMIP. The messages received from heterogeneous platforms are first converted to a uniform message, and then the uniform message is transferred by the UMIP, and finally the received uniform message is converted into the format used by the receiver platform. That is, the UMIP and the uniform message are used as the communication medium across heterogeneous platforms in the present invention.

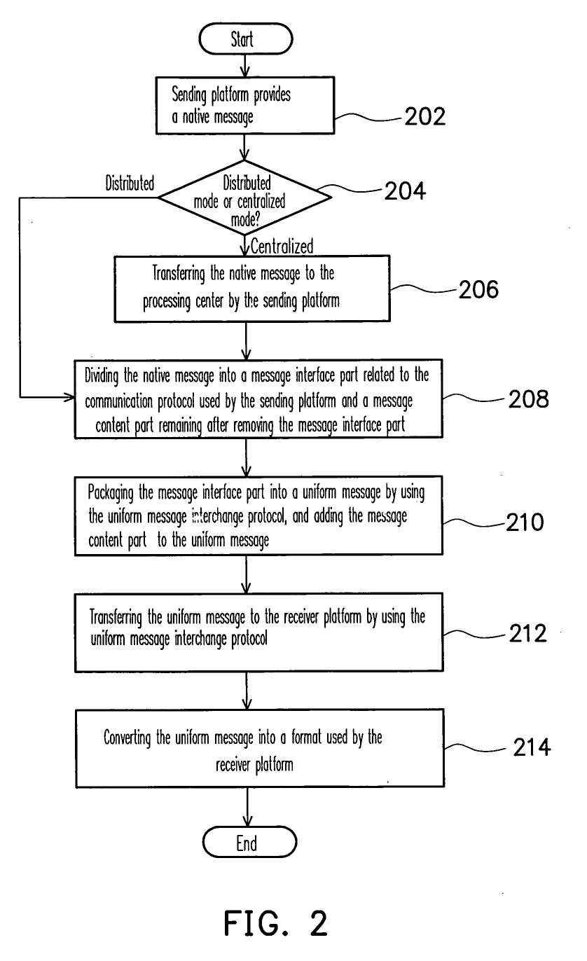

A method for uniform message interchange provided by the present invention is described in FIG. 2. First, in step 202, a native message is provided by a sender platform, wherein the native message may be an e-mail, a mobile phone short message, an instant message, a facsimile, or any type of information data. Then, in step 204, it is determined whether the system using the UMIP is operated in a distributed mode or in a centralized mode. If it is in the centralized mode, in step 206, the native message is sent to a processing center by the sender platform, and steps 208, 210, and 212 are performed in the processing center. If it is in the distributed mode, step 206 is skipped and steps 208, 210, and 212 are directly performed in the sender platform.

Wherein, in step 208, the native message is divided into a message interface part related to the communication protocol used by the sender platform and a message content part remaining after removing the message interface part (i.e. a part that is unrelated to the communication protocol, or the content to be sent to the receiver by the sender). Here, the communication protocol used by the sender platform may be SMTP (simple mail transfer protocol), HTTP (hypertext transfer protocol), FTP (file transfer protocol), TCP (transport control protocol), or other communication protocol. Then, in step 210, the message interface part is packaged into a uniform message by using the UMIP; that is, the message interface part written with the communication protocol used by the sender platform is revised based on the UMIP, and the message content part is added into the uniform message.

After the conversion of the uniform message is completed, in step 212, the uniform message is transferred to the receiver platform by using the UMIP. Finally, in step 214, the receiver platform converts the received uniform message into the format that the platform uses.

Other embodiments of the present invention are related to two types of uniform message interchange systems, wherein one is a distributed system, the other one is a centralized system. The following embodiment is the distributed system according to the present invention.

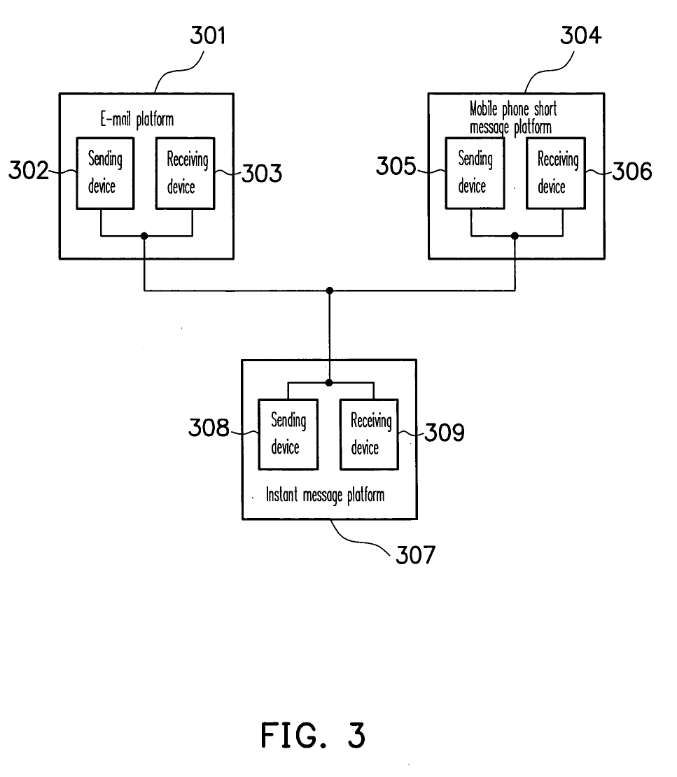

FIG. 3 schematically shows a distributed system for uniform message interchange according to the present invention. As shown in the diagram, there are three communication platforms, including an e-mail platform 301, a mobile phone short message platform 304, and an instant message platform 307, and each communication platform includes a sending device and a receiving device, respectively. In the present embodiment, the system for uniform message interchange includes the sending device and the receiving device.

It is assumed that an e-mail on the e-mail platform 301 is to be sent to a receiver on the instant message platform 307. First, the sending device 302 on the e-mail platform 301 would divide the e-mail into a message interface part related to the communication protocol used by the e-mail platform 301 and a message content part unrelated to the communication protocol used by the e-mail platform 301. Then, the message interface part is packaged into a uniform message by using the UMIP, and the message content part is added into the uniform message. Finally, the uniform message is transferred by using the UMIP.

After the uniform message had been sent out, the receiving device 309 on the instant message platform 307 receives the uniform message, and converts the received uniform message into a message format that the platform uses; that is, the received uniform message is converted into an instant message. Then, the converted message is transferred to the receiver by the instant message platform 307. Accordingly, the interchange of messages across the e-mail platform 301 and the instant message platform 307 is accomplished.

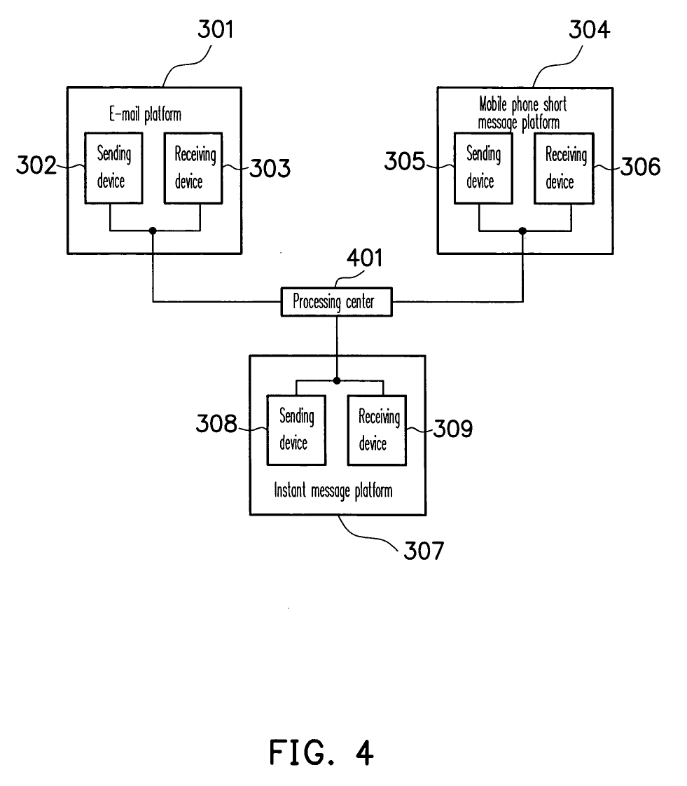

A centralized system for uniform message interchange according to the present invention is shown in FIG. 4 as another embodiment. The embodiment shown in FIG. 4 is similar to the one shown in FIG. 3 except a processing center 401 is added into the configuration in FIG. 4 as an interchange control center among three communication platforms. It is noted that the processing center 401 can be constructed within the sending device as well. The system for uniform message interchange of the present embodiment includes a sending device, a receiving device, and a processing center.

Similarly, it is assumed that an e-mail on the e-mail platform 301 is to be sent to a receiver on the instant message platform 307. First, the sending device 302 on the e-mail platform 301 receives the e-mail and transfers it to the processing center 401. Then, the processing center 401 receives the e-mail, divides the received e-mail into a message interface part related to the communication protocol used by the e-mail platform 301 and a message content part unrelated to the communication protocol used by the e-mail platform 301. Then, the message interface part is packaged into a uniform message by using the UMIP, and the message content part is added into the uniform message. Finally, the uniform message is transferred by using the UMIP.

Similar to the previous embodiment, after the uniform message had been sent out, the receiving device 309 on the instant message platform 307 receives the uniform message, and converts the received uniform message into a message format that the platform uses; that is, the received uniform message is converted into an instant message. Then, the converted message is transferred to the receiver by the instant message platform 307. Accordingly, the interchange of messages across the e-mail platform 301 and the instant message platform 307 is accomplished.

All embodiments mentioned above use the same uniform message format, which is formed with reference to the similarity of the commonly used message formats, and extracting and extending the common points therein.

For example, an e-mail (electronic mail) transmitted by SMTP is roughly composed of a Header part and a Body part. Wherein, the Header part at least includes a “From Address”, a “To Address”, and a “Date”. Similarly, a short message service (SMS) transmitted by the GSM (global system for mobile communication)/GPRS (global packetized radio service/CDMA (code division multiple access) is roughly composed of a Header part and a Body part. Wherein, the Header part at least includes a “From Number”, a “To Number”, a “Date”, and a “Type”. An instant message transmitted by TCP/IP (Internet Protocol) is roughly composed of a Header part and a Body part. Wherein, the Header part at least includes a “From Number”, and a “To Number”, etc. Therefore, the UMIP supporting multiple platforms can be configured not limited by various communication protocols to integrate the extracted similarities among the various communication protocols.

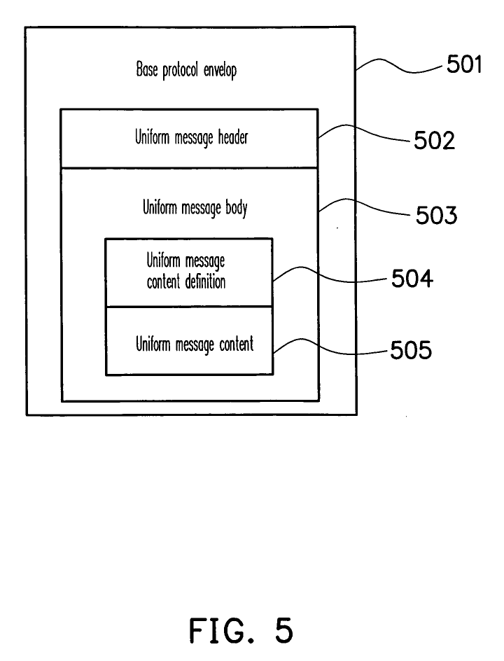

FIG. 5 schematically shows a uniform message format used in an embodiment of the present invention. The base protocol envelop 501 on the outermost layer indicates the transmitting method of the uniform message on the WAN (wide area network) based on the communication protocol supporting the Internet environment, such as SMTP, HTTP, FTP, and TCP, and a packet of a UMIP identification envelop is further added in order to deliver the UMIP message.

The content of the base protocol envelop 501 is composed of two parts. One is a uniform message header (UMH) 502 for defining a uniform message identification and a warp format of the uniform message. The other one is a uniform message body (UMB) 503 for storing the content of the delivered uniform message. The uniform message body 503 is further composed of two parts. One is a uniform message content definition (UMCD) 504 for defining the content of the delivered uniform message, and the other one is a real uniform message content (UMC) 505.

In summary, the method and the system in the present invention are mainly characterized in that the uniform message and the UMIP are used as a communication medium. First, all of the native messages from various communication platforms are converted to the uniform message that is formed by integrating the extracted similarities among the various communication protocols. Then, the uniform message is transferred to the receiver platform by using the UMIP. Finally, the receiver platform converts the received uniform message into the format that the platform uses. Therefore, it is only required to develop an interchange system among the various communication platforms and the uniform message interchange protocols, but not to develop an interchange system for each combination of the various communication platforms. Accordingly, the delivery of messages across platforms is simplified and unrelated to the details of the various communication protocols, such that the cost of message interchange across platforms can be reduced and efficiency of developing the system can be improved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for uniform message interchange, comprising:
(a) receiving a native message from a sender platform;
(b) dividing the native message into a message interface part related to a communication protocol used by the sender platform and a message content part unrelated to the communication protocol used by the sender platform;
(c) packaging the message interface part into a uniform message by using a uniform message interchange protocol, and adding the message content part into the uniform message; and
(d) transmitting the uniform message to a receiver platform by using the uniform message interchange protocol.

2. The method for uniform message interchange of claim 1, wherein the receiver platform converts the uniform message to a format used by the receiver platform.

3. The method for uniform message interchange of claim 1, wherein when the steps from (b) to (d) are performed in a processing center, the method for uniform message interchange further comprises the following step between the step (a) and the step (b):
transmitting the native message to the processing center by the sender platform.

4. The method for uniform message interchange of claim 1, wherein the native message is selected from a group comprising an e-mail, a mobile phone short message, an instant message, a facsimile, and any combination of the items mentioned above.

5. The method for uniform message interchange of claim 1, wherein the communication protocol used by the sender platform is selected from a group comprising SMTP (simple mail transfer protocol), HTTP (hypertext transfer protocol), FTP (file transfer protocol), TCP (transport control protocol), and any combination of the items mentioned above.

6. The method for uniform message interchange of claim 1, wherein the uniform message at least comprises a sender identification information, a receiver identification information, a type of the sender platform, and a type of the receiver platform.

7. The method for uniform message interchange of claim 1, further comprising:
packaging a base protocol envelop by adding a uniform message interchange protocol identification envelop into the uniform message.

8. The method for uniform message interchange of claim 7, wherein the base protocol envelop comprises a uniform message header which defines an identification information and a wrap format of the uniform message and a uniform message body which stores a content of the delivered uniform message.

9. The method for uniform message interchange of claim 8, wherein the uniform message body comprises a uniform message content definition which defines the content of the delivered uniform message and a uniform message content.

10. A system for uniform message interchange, comprising:
a sending device for dividing a native message into a message interface part related to a communication protocol used by a platform of the sending device and a message content part unrelated to the communication protocol used by the platform of the sending device, packaging the message interface part into a uniform message by using a uniform message interchange protocol, adding the message in the message content part related to the receiver to the uniform message, and transmitting the uniform message by using the uniform message interchange protocol; and
a receiving device for receiving the uniform message sent by the sending device, and converting the uniform message into a format used by a platform of the receiving device.

11. The system for uniform message interchange of claim 10, wherein the native message is selected from a group comprising an e-mail, a mobile phone short message, an instant message, a facsimile, and any combination of the items mentioned above.

12. The system for uniform message interchange of claim 10, wherein the communication protocol used by the platform of the sending device is selected from a group comprising SMTP, HTTP, FTP, TCP, and any combination of the items mentioned above.

13. A system for uniform message interchange, comprising:
a sending device for providing and sending a native message;
a processing center for receiving the native message sent by the sending device, dividing the native message into a message interface part related to a communication protocol used by a platform of the sending device and a message content part remaining after removing the message interface part from the native message, packaging the message interface part into a uniform message by using a uniform message interchange protocol, adding the message in the message content part related to the receiver to the uniform message, and transmitting the uniform message by using the uniform message interchange protocol; and
a receiving device for receiving the uniform message sent by the processing center, and converting the uniform message into a format used by a platform of the receiving device.

14. The system for uniform message interchange of claim 13, wherein the native message is selected from a group comprising an e-mail, a mobile phone short message, an instant message, a facsimile, and any combination of the items mentioned above.

15. The system for uniform message interchange of claim 13, wherein the communication protocol used by the platform of the sending device is selected from a group comprising SMTP, HTTP, FTP, TCP, and any combination of the items mentioned above.

16. The system for uniform message interchange of claim 13, wherein the processing center is constructed within the sending device.
